(19) United States
(12) Patent Application Publication
(10) Pub. No.: US 2021/0309191 A1
(43) Pub. Date: Oct. 7, 2021

(54) LOCOMOTIVE BRAKING CONTROL SYSTEM AND CONTROL METHOD

(71) Applicants: CRRC QINGDAO SIFANG ROLLING STOCK RESEARCH INSTITUTE CO., LTD., QINGDAO (CN); QINGDAO SRI TECHNOLOGY CO., LTD., QINGDAO (CN)

(72) Inventors: XIAO LV, QINGDAO (CN); XIANGJIE REN, QINGDAO (CN); ZHIQIANG ZHANG, QINGDAO (CN); GUANWEN ZHU, QINGDAO (CN); BIN SUN, QINGDAO (CN); RUBO GE, QINGDAO (CN)

(21) Appl. No.: 17/328,995

(22) Filed: May 24, 2021

Related U.S. Application Data
(63) Continuation of application No. PCT/CN2019/092874, filed on Jun. 26, 2019.

(30) Foreign Application Priority Data
Mar. 1, 2019 (CN) 201910156513.4

(51) Int. Cl. B60T 8/17; B60T 8/171; B60T 8/172; B60T 8/88; B60T 13/68; B60T 7/08

(52) U.S. Cl. CPC B60T 8/1705; B60T 8/171; B60T 8/172; B60T 2270/88; B60T 13/683; B60T 7/08; B60T 2270/406; B60T 8/885

(57) ABSTRACT

The present application belongs to the field of locomotive braking control, and relates to a locomotive braking control system and control method, including a brake cylinder equalizing pipe control system and a brake cylinder control system; wherein, the brake cylinder equalizing pipe control system can compare pre-control pressure of the brake cylinder and the pre-control pressure of the brake cylinder equalizing pipe, and output the higher one as the brake cylinder equalizing pipe pressure; and the brake cylinder control system can compare pre-control pressure of the brake cylinder and the brake cylinder equalizing pipe pressure, and output the higher one as the brake cylinder pressure to realize brake; the redundancy of the two control systems can also be realized.

### CROSS-REFERENCE TO RELATED APPLICATIONS

This application is a continuation of PCT/CN2019/092874 filed on Jun. 26, 2019, which claims the priority benefit of Chinese patent application No. 201910156513.4 filed on Mar. 1, 2019. The entirety of the above-mentioned patent applications is hereby incorporated by reference herein and made a part of this specification.

### TECHNICAL FIELD

The present application relates to a locomotive braking control system and control method, belonging to the field of locomotive braking control.

### BACKGROUND

One of the important functions of a locomotive braking control system is to control the brake cylinder equalizing pipe pressure and the brake cylinder pressure;

conventionally, a pre-control pressure is controlled by a high-frequency magnet valve, and then the brake cylinder equalizing pipe pressure or brake cylinder pressure, which is consistent with the pre-control pressure, is output by a relay valve.

CN104442903A discloses a brake cylinder equalizing pipe control method and device of a locomotive brake. The device includes: an air source filtration device; a first magnet valve, a pressure amplification valve and a third magnet valve connected with the air source filtration device and disposed on an air line mounting plate; a second magnet valve connected with the first magnet valve and disposed on the air line mounting plate; a control unit and a pressure detection device connected with the first magnet valve and the second magnet valve; a control reservoir connected with the pressure amplification valve and the pressure detection device; and a pneumatic reversing valve connected with the pressure amplification valve and the third magnet valve, wherein an air outlet of the pneumatic reversing valve is connected with an output port of the brake cylinder equalizing pipe.

### SUMMARY

A first embodiment of the present application provides a locomotive braking control system, comprising a brake cylinder equalizing pipe control system and a brake cylinder control system, wherein,

The brake cylinder equalizing pipe control system includes:

a first main reservoir;

a first magnet valve and a first flow amplification valve both connected with the first main reservoir;

a second magnet valve connected with the first magnet valve;

a first pressure selection device connected with the second magnet valve, and a first pressure detection device located between the second magnet valve and the first pressure selection device;

wherein, the first pressure selection device is connected with the first flow amplification valve; and

the brake cylinder equalizing pipe control system further includes a first control unit electrically connected with the first magnet valve, the second magnet valve and the first pressure detection device.

The brake cylinder control system includes:

a second main reservoir;

a third magnet valve and a second flow amplification valve both connected with the second main reservoir;

a fourth magnet valve connected with the third magnet valve;

a second pressure selection device connected with the fourth magnet valve, and a second pressure detection device located between the fourth magnet valve and the second pressure selection device;

wherein, the second pressure selection device is connected with the second flow amplification valve;

the second flow amplification valve is connected with a brake cylinder pipe so as to realize brake; and

the brake cylinder control system further includes a second control unit electrically connected with the third magnet valve, the fourth magnet valve and the second pressure detection device.

Between the brake cylinder equalizing pipe control system and the brake cylinder control system:

the first pressure selection device is connected to a pipeline located between the fourth magnet valve and the second pressure selection device; and

the first flow amplification valve is connected to the second pressure selection device.

Furtherly,

the first pressure detection device is configured to acquire a pre-control pressure of the brake cylinder equalizing pipe control system in real time and transmit the acquired pre-control pressure to the first control unit, thus obtain a pre-control pressure actual value of the brake cylinder equalizing pipe.

The first control unit is configured to, when the locomotive braking control system is in a lead cut in mode, receive instruction information output by a brake handle operated by a driver and calculate a pre-control pressure target value of the brake cylinder equalizing pipe according to the instruction information; or, the first control unit receives a first target value from an integrated control unit, and the integrated control unit is configured to, when the locomotive braking control system is in the lead cut in mode, receive the instruction information output by the brake handle operated by the driver and calculate a first target value according to the instruction information, wherein the first target value and the pre-control pressure target value of the brake cylinder equalizing pipe are equal, and are collectively referred to as a target value.

The first control unit is further configured to compare the target value with the actual value acquired by the first pressure detection device, and control the first magnet valve and/or the second magnet valve according to a difference of the target value and the actual value so that the actual value is equal to the target value, thus obtain the pre-control pressure of the brake cylinder equalizing pipe; and transmit the pre-control pressure of the brake cylinder equalizing pipe to the first pressure selection device.

The first magnet valve is a pre-control air-charging magnet valve, and is configured to open or close an air-charging passage from the first main reservoir to a pre-control volume of the brake cylinder equalizing pipe control system according to the difference of the pre-control pressure target value of the brake cylinder equalizing pipe and the pre-control pressure actual value of the brake cylinder equalizing pipe.

The second magnet valve is a pre-control air-discharging magnet valve, and is configured to open or close an air-discharging passage from the pre-control volume of the brake cylinder equalizing pipe control system to the atmosphere according to the difference of the pre-control pressure target value of the brake cylinder equalizing pipe and the pre-control pressure actual value of the brake cylinder equalizing pipe.

The first pressure selection device is configured to compare the pre-control pressure of the brake cylinder equalizing pipe with a pre-control pressure of a brake cylinder, and output a higher pressure, referred to as a first pressure, among the pre-control pressure of the brake cylinder equalizing pipe and the pre-control pressure of the brake cylinder to the first flow amplification valve; and the pre-control pressure of the brake cylinder is from the brake cylinder control system.

The first flow amplification valve is configured to amplify the first pressure with low-flow to a brake cylinder equalizing pipe pressure with high-flow.

The second pressure detection device is configured to acquire a pre-control pressure of the brake cylinder control system in real time and transmit the acquired pre-control pressure to the second control unit, thus obtain a pre-control pressure actual value of the brake cylinder.

The second control unit is configured to, when the locomotive braking control system is in the lead cut in mode, receive the instruction information output by the brake handle operated by the driver and calculate a pre-control pressure target value of the brake cylinder according to the instruction information, wherein the pre-control pressure target value of the brake cylinder is equal to the pre-control pressure target value of the brake cylinder equalizing pipe; or, when the locomotive braking control system is in the lead cut in mode, the second control unit receives the first target value from the integrated control unit.

The second control unit is further configured to compare the target value with the actual value acquired by the second pressure detection device, and control the third magnet valve and/or the fourth magnet valve according to a difference of the target value and the actual value so that the actual value is equal to the target value, thus obtain the pre-control pressure of the brake cylinder; and transmit the pre-control pressure of the brake cylinder to the second pressure selection device and the first pressure selection device.

The third magnet valve is a pre-control air-charging magnet valve, and is configured to open or close an air-charging passage from the second main reservoir to a pre-control volume of the brake cylinder control system according to the difference of the pre-control pressure target value of the brake cylinder and the pre-control pressure actual value of the of the brake cylinder.

The fourth magnet valve is a pre-control air-discharging magnet valve, and is configured to open or close an air-discharging passage from the pre-control volume of the brake cylinder control system to the atmosphere according to the difference of the pre-control pressure target value of the brake cylinder and the pre-control pressure actual value of the brake cylinder.

The second pressure selection device is configured to compare the brake cylinder equalizing pipe pressure with the pre-control pressure of the brake cylinder, and output a higher pressure, referred to as a second pressure, among the brake cylinder equalizing pipe pressure and the pre-control pressure of the brake cylinder to the second flow amplification valve; and the brake cylinder equalizing pipe pressure is from the brake cylinder equalizing pipe control system.

The second flow amplification valve is configured to amplify the second pressure with low-flow to a brake cylinder pressure with high-flow, and transmit the brake cylinder pressure to the brake cylinder pipe, to realize brake.

A second embodiment of the present application provides a locomotive braking control method, in which the above-mentioned control system can be adopted, including the following steps:

acquiring, by the first pressure detection device, a pre-control pressure of the brake cylinder equalizing pipe control system in real time, and transmitting the acquired pre-control pressure to the first control unit, thus obtaining a pre-control pressure actual value of the brake cylinder equalizing pipe;

when the locomotive braking control system is in a lead cut in mode, receiving, by the first control unit, instruction information output by a brake handle operated by a driver, and calculating a pre-control pressure target value of the brake cylinder equalizing pipe according to the instruction information; or, when the locomotive braking control system is in the lead cut in mode, receiving, by an integrated control unit, the instruction information output by the brake handle operated by the driver, and calculating a first target value according to the instruction information, and receiving, by the first control unit, the first target value from the integrated control unit, wherein the first target value and the pre-control pressure target value of the brake cylinder equalizing pipe are equal and are collectively referred to as a target value;

comparing, by the first control unit, the target value with the actual value, and controlling the first magnet valve and/or the second magnet valve according to a difference of the target value and the actual value so that the actual value is equal to the target value, thus obtaining the pre-control pressure of the brake cylinder equalizing pipe; and transmitting the pre-control pressure of the brake cylinder equalizing pipe to the first pressure selection device;

acquiring, by the second pressure detection device, a pre-control pressure of the brake cylinder control system in real time, and transmitting the acquired pre-control pressure to the second control unit, thus obtaining a pre-control pressure actual value of the brake cylinder;

when the locomotive braking control system is in the lead cut in mode, receiving, by the second control unit, instruction information output by the brake handle operated by the driver, and calculating a pre-control pressure target value of the brake cylinder according to the instruction information, wherein the pre-control pressure target value of the brake cylinder is equal to the pre-control pressure target value of the brake cylinder equalizing pipe; or, when the locomotive braking control system is in the lead cut in mode, receiving, by the second control unit, the first target value from the integrated control unit;

comparing, by the second control unit, the target value with the actual value, and controlling the third magnet valve and/or the fourth magnet valve according to a difference of the target value and the actual value so that the actual value is equal to the target value, thus obtaining the pre-control pressure of the brake cylinder; and transmitting the pre-control pressure of the brake cylinder to the second pressure selection device and the first pressure selection device;

comparing, by the first pressure selection device, the pre-control pressure of the brake cylinder equalizing pipe with the pre-control pressure of the brake cylinder, and outputting a higher pressure, referred to as a first pressure, among the pre-control pressure of the brake cylinder equalizing pipe and the pre-control pressure of the brake cylinder to the first flow amplification valve;

amplifying, by the first flow amplification valve, the first pressure with low-flow to a brake cylinder equalizing pipe pressure with high-flow, and outputting the brake cylinder equalizing pipe pressure to the second pressure selection device;

comparing, by the second pressure selection device, the brake cylinder equalizing pipe pressure with the pre-control pressure of the brake cylinder, and outputting a higher pressure, referred to as a second pressure, among the brake cylinder equalizing pipe pressure and the pre-control pressure of the brake cylinder to the second flow amplification valve; and

amplifying, by the second flow amplification valve, the second pressure with low-flow to a brake cylinder pressure with high-flow, and transmitting the brake cylinder pressure to the brake cylinder pipe so as to realize brake.

A third embodiment of the present application provides a locomotive braking control method by which redundancy switching between the brake cylinder equalizing pipe control system and the brake cylinder control system can be realized:

when the pre-control pressure of the brake cylinder equalizing pipe is invalid, the first magnet valve 101 and the second magnet valve 102 are de-energized, the pre-control pressure of the brake cylinder equalizing pipe is gradually reduced to zero, and the first pressure selection device 104 selects the higher pre-control pressure of the brake cylinder as the first pressure to be output to the first flow amplification valve 106, and then the brake cylinder equalizing pipe pressure is output; or

when the pre-control pressure of the brake cylinder is invalid, the third magnet valve 201 and the fourth magnet valve 202 are de-energized, the pre-control pressure of the brake cylinder is gradually reduced to zero, and the second pressure selection device 204 selects the higher brake cylinder equalizing pipe pressure as the second pressure to be output to the second flow amplification valve 206, and then the brake cylinder pressure is output.

Compared with the prior art, the present application has the following beneficial effects:
(1) the mutual cooperation of the brake cylinder equalizing pipe control system and the brake cylinder control system is realized; and
(2) when failure occurs on a pre-control part of the brake cylinder equalizing pipe control system or that of the brake cylinder control system, the pre-control part of the brake cylinder equalizing pipe control system and that of the brake cylinder control system can be mutually redundant, so that the control precision and reliability of the locomotive braking control system can be effectively improved.

### BRIEF DESCRIPTION OF THE DRAWINGS

FIG. 1 is a schematic diagram of a first embodiment of a locomotive braking control system;

FIG. 2 is a schematic diagram of a second embodiment of the locomotive braking control system;

FIG. 3 is a schematic diagram of an example of the locomotive braking control system;

FIG. 4 is a schematic diagram of an embodiment of a control unit;

wherein: 1 brake cylinder equalizing pipe control system, 101 first magnet valve, 102 second magnet valve, 103 first main reservoir, 104 first pressure selection device, 105 first pressure detection device, 106 first flow amplification valve, 107 first pre-control reservoir, 108 cut-off valve, 109 third pressure detection device, 110 first control unit, 111 first pipeline, 112 third pipeline; 2 brake cylinder control system, 201 third magnet valve, 202 fourth magnet valve, 203 second main reservoir, 204 second pressure selection device, 205 second pressure detection device, 206 second flow amplification valve, 207 fifth magnet valve, 208 mechanical distribution valve, 209 sixth magnet valve, 210 second pre-control reservoir, 211 fourth pressure detection device, 212 brake cylinder pipe, 213 second control unit, 214 second pipeline, 215 fourth pipeline; and 3 integrated control unit.

### DETAILED DESCRIPTION OF THE EMBODIMENTS

The technical solutions of the present application will be described in detail below in combination with specific embodiments. However, it should be understood that elements, structures and features in one embodiment may also be advantageously incorporated into other embodiments without further description.

In the description of the present application, it should be noted that terms such as “first” and “second” are used for descriptive purposes only, and cannot be understood as indicating or implying the relative importance. Unless otherwise specified and defined, the connection may be direct connection or indirect connection through an intermediate medium, and may be internal connection of two elements. The embodiments are only described as preferred embodiments of the present application, and are not intended to limit the scope of the present application. Various modifications and improvements made on the technical solutions of the present application by ordinary skill in the art without departing from the design spirit of the present application shall fall within the protective scope confirmed by the claims of the present application.

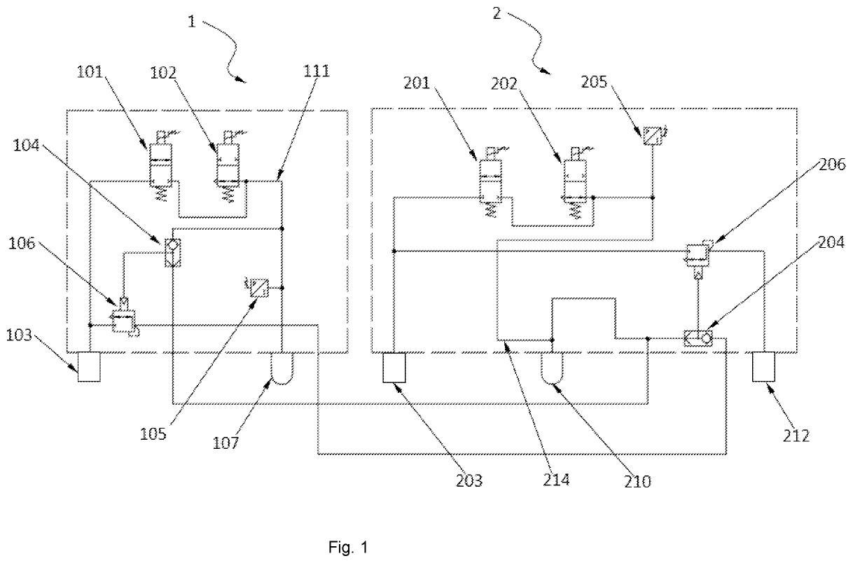

An embodiment of the present application provides a locomotive braking control system, as shown in FIG. 1, including a brake cylinder equalizing pipe control system 1 and a brake cylinder control system 2.

(1) The brake cylinder equalizing pipe control system 1 includes:

a first main reservoir 103; a first magnet valve 101 and a first flow amplification valve 106 both connected with the first main reservoir 103; a second magnet valve 102 connected with the first magnet valve 101; a first pressure selection device 104 connected with the second magnet valve 102 and a first pressure detection device 105 located therebetween; and the first pressure selection device 104 is connected with the first flow amplification valve 106. The brake cylinder equalizing pipe control system 1 further includes a first control unit 110 electrically connected with the first magnet valve 101, the second magnet valve 102 and the first pressure detection device 105.

(2) The brake cylinder control system 2 includes:

a second main reservoir 203; a third magnet valve 201 and a second flow amplification valve 206 both connected with the second main reservoir 203;

a fourth magnet valve 202 connected with the third magnet valve 201; a second pressure selection device 204 connected with the fourth magnet valve 202 and a second pressure detection device 205 located therebetween; the second pressure selection device 204 is connected with the second flow amplification valve 206, and the second flow amplification valve 206 is connected with a brake cylinder pipe 212, so as to realize brake. The brake cylinder control system 2 further includes a second control unit 213 electrically connected with the third magnet valve 201, the fourth magnet valve 202 and the second pressure detection device 205.

(3) Between the brake cylinder equalizing pipe control system 1 and the brake cylinder control system 2:

the first pressure selection device 104 is connected to a second pipeline 214 located between the fourth magnet valve 202 and the second pressure selection device 204; and the first flow amplification valve 106 is connected to the second pressure selection device 204.

Further,

the first pressure detection device 105 is configured to acquire a pre-control pressure of the brake cylinder equalizing pipe control system 1 in real time and transmit the acquired pre-control pressure to the first control unit 110 to obtain a pre-control pressure actual value of the brake cylinder equalizing pipe.

The first control unit 110 is configured to, when the locomotive braking control system is in a lead cut in mode, receive instruction information output by a brake handle operated by a driver and calculate a pre-control pressure target value of the brake cylinder equalizing pipe according to the instruction information; or, the first control unit 110 receives a first target value from the integrated control unit, and the integrated control unit is configured to, when the locomotive braking control system is in the lead cut in mode, receive instruction information output by the brake handle operated by the driver and calculate the first target value according to the instruction information, wherein the first target value and the pre-control pressure target value of the brake cylinder equalizing pipe are equal.

The first control unit 110 is further configured to compare the target value with the actual value (that is, the pre-control pressure actual value of the brake cylinder equalizing pipe) acquired by the first pressure detection device 105, and control the first magnet valve 101 and/or the second magnet valve 102 according to a difference of the target value and the actual value so that the actual value is equal to the target value, thus obtain the pre-control pressure of the brake cylinder equalizing pipe; and transmit the pre-control pressure of the brake cylinder equalizing pipe to the first pressure selection device 104.

The first magnet valve 101 is a pre-control air-charging magnet valve, and is configured to open or close an air-charging passage from the first main reservoir 103 to a pre-control volume of the brake cylinder equalizing pipe control system 1 according to the difference of the pre-control pressure target value of the brake cylinder equalizing pipe and the pre-control pressure actual value of the brake cylinder equalizing pipe.

Seen from FIG. 1, the pre-control volume can refer to a volume of a first pipeline 111 located between the second magnet valve 102 and the first pressure selection device 104; and a pressure of the volume of the pipeline is the pre-control pressure of the brake cylinder equalizing pipe.

The second magnet valve 102 is a pre-control air-discharging magnet valve, and is configured to open or close an air-discharging passage from the pre-control volume of the brake cylinder equalizing pipe control system 1 to the atmosphere according to the difference of the pre-control pressure target value of the brake cylinder equalizing pipe and the pre-control pressure actual value of the brake cylinder equalizing pipe.

The first pressure selection device 104 is configured to compare the pre-control pressure of the brake cylinder equalizing pipe with a pre-control pressure of a brake cylinder, and output a higher pressure thereof, referred to as a first pressure, to the first flow amplification valve 106; and the pre-control pressure of the brake cylinder is from the brake cylinder control system 2.

The first flow amplification valve 106 is configured to amplify the first pressure with low-flow of the brake cylinder equalizing pipe control system 1 to a brake cylinder equalizing pipe pressure with high-flow.

The second pressure detection device 205 is configured to acquire a pre-control pressure of the brake cylinder control system 2 in real time and transmit the acquired pre-control pressure to the second control unit 213 to obtain a pre-control pressure actual value of the brake cylinder.

The second control unit 213 is configured to, when the locomotive braking control system is in the lead cut in mode, receive the instruction information output by the brake handle operated by the driver and calculate a pre-control pressure target value of the brake cylinder according to the instruction information, wherein the pre-control pressure target value of the brake cylinder is equal to the pre-control pressure target value of the brake cylinder equalizing pipe; or, when the locomotive braking control system is in the lead cut in mode, the second control unit 213 receives the first target value from the integrated control unit.

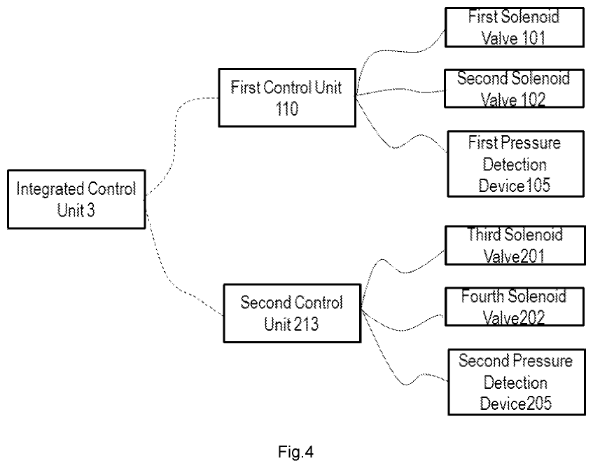

It should be noted that the pre-control pressure target value of the brake cylinder equalizing pipe, the pre-control pressure target value of the brake cylinder and the first target value are equal, thus they are collectively referred to as the target value. Known from the aforementioned description, the target value may be respectively calculated by the first control unit 110 and the second control unit 213, or may be calculated by the integrated control unit and then the obtained target value is distributed to the first control unit 110 and the second control unit 213, as shown in FIG. 4. The integrated control unit 3 in FIG. 4 is connected with the first control unit 110 and the second control unit 213 by dotted lines, which means that the present application may be achieved in a way that the first control unit and the second control unit are controlled by the integrated control unit, or the present application may be achieved without the integrated control unit.

The second control unit 213 is further configured to compare the target value with the actual value (that is, the pre-control pressure actual value of the brake cylinder) acquired by the second pressure detection device 205, and control the third magnet valve 201 and/or the fourth magnet valve 202 according to a difference of the target value and the actual value so that the actual value is equal to the target value, thus obtain the pre-control pressure of the brake cylinder; and transmit the pre-control pressure of the brake cylinder to the second pressure selection device 204 and the first pressure selection device 104.

The third magnet valve 201 is a pre-control air-charging magnet valve, and is configured to open or close an air-charging passage from the second main reservoir 203 to a pre-control volume of the brake cylinder control system 2 according to the difference of the pre-control pressure target value of the brake cylinder and the pre-control pressure actual value of the brake cylinder.

Seen from FIG. 1, the pre-control volume can refer to a volume of the second pipeline 214 located between the fourth magnet valve 202 and the second pressure selection device 204; and a pressure of the volume of the pipeline is the pre-control pressure of the brake cylinder.

The fourth magnet valve 202 is a pre-control air-discharging magnet valve, and is configured to open or close an air-discharging passage from the pre-control volume of the brake cylinder control system 2 to the atmosphere according to the difference of the pre-control pressure target value of the brake cylinder and the pre-control pressure actual value of the brake cylinder.

The second pressure selection device 204 is configured to compare the brake cylinder equalizing pipe pressure with the pre-control pressure of the brake cylinder, and output a higher pressure thereof, referred to as a second pressure, to the second flow amplification valve 206; and the brake cylinder equalizing pipe pressure is from the brake cylinder equalizing pipe control system 1.

The second flow amplification valve 206 is configured to amplify the second pressure with low-flow of the brake cylinder control system 2 to a brake cylinder pressure with high-flow, and transmit the brake cylinder pressure to the brake cylinder pipe 212, to realize brake.

As a preferred embodiment, the pressure detection devices 105, 205 may select from, but are not limited to, pressure sensors.

As a preferred embodiment, the pressure selection devices 104, 204 may select from, but are not limited to, two-way valves, or two-position three-way magnet valves;

as a two-position three-way magnet valve is required to be additionally electrically controlled, a two-way valve is preferred.

As a preferred embodiment, the flow amplification valves 106, 206 may select from, but are not limited to, relay valves.

As a preferred embodiment, the first main reservoir 103 and the second main reservoir 203 can be the same main reservoir or different main reservoirs.

As a preferred embodiment, as shown in FIG. 1, the second magnet valve 102 is further connected with a first pre-control reservoir 107 to increase the pre-control volume of the brake cylinder equalizing pipe control system 1. A pre-control pressure of the first pre-control reservoir 107 can be acquired by the first pressure detection device 105 in real time and be transmitted to the first control unit 110 so as to be used as the pre-control pressure actual value of the brake cylinder equalizing pipe; and then, the actual value is compared with the target value, and by controlling the first magnet valve 101 and/or the second magnet valve 102, the pre-control pressure actual value of the brake cylinder equalizing pipe and the target value are equal. The first pre-control reservoir 107 is capable of increasing the pre-control volume of the brake cylinder equalizing pipe, and besides the first pipeline 111 can be used as the pre-control volume, the pre-control reservoir can also be used as a part of the pre-control volume, and thus, it is convenient to realize pressure control.

As a preferred embodiment, as shown in FIG. 1, the fourth magnet valve 202 is further connected with a second pre-control reservoir 210 to increase the pre-control volume of the brake cylinder control system 2; and the working principle of the second pre-control reservoir 210 is the same as that of the first pre-control reservoir, the descriptions thereof are omitted herein. Meanwhile, it can be further known that the second pre-control reservoir 210 is located at the front ends of the first pressure selection device 104 and the second pressure selection device 204. The front end or rear end in the present application is mainly described with respect to the flow direction of the air pressure.

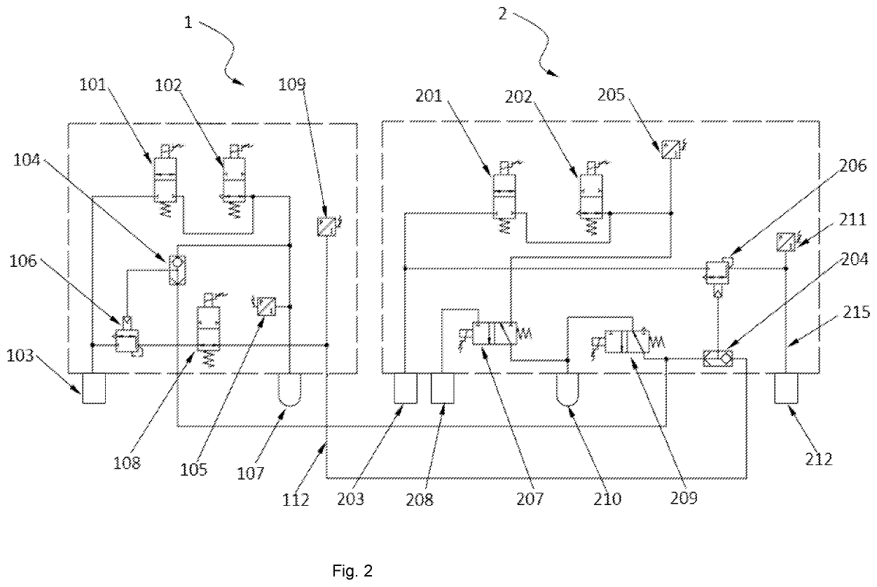

As a preferred embodiment, as shown in FIG. 2, the first control unit 110 can be further electrically connected with a cut-off valve 108. The cut-off valve 108 is located in the brake cylinder equalizing pipe control system 1, is preferably located behind the first flow amplification valve 106 and is used for opening or closing a brake cylinder equalizing pipe pressure output pipeline of the brake cylinder equalizing pipe control system 1.

When the locomotive braking control system is in the lead cut in mode, the first control unit 110 controls the cut-off valve 108 to be de-energized, and the brake cylinder equalizing pipe pressure output pipeline is in a connected state; and when the locomotive braking control system is in a trail mode, the first control unit 110 controls the cut-off valve 108 to be energized, the brake cylinder equalizing pipe pressure output pipeline is in a closed state, and thus, an air pressure from an external interface (unshown in the figures) can be prevented from further entering the brake cylinder equalizing pipe control system 1.

As a preferred embodiment, as shown in FIG. 2, in the brake cylinder control system 2, the second control unit 213 is further electrically connected with a fifth magnet valve 207 which is a distribution valve switching magnet valve. The fifth magnet valve 207 is connected with the fourth magnet valve on one hand, is connected with a mechanical distribution valve 208 on the other hand, and is connected with the second pressure selection device 204 on another hand; and the fifth magnet valve 207 is used for switching and selecting a source of the pre-control pressure of the brake cylinder.

Specifically, when the fifth magnet valve 207 is energized, the pre-control pressure of the brake cylinder is from the pre-control pressure generated by the third magnet valve 201 and the fourth magnet valve 202; and when the fifth magnet valve 207 is de-energized, the pre-control pressure of the brake cylinder is from the mechanical distribution valve 208 which is externally connected. When the locomotive braking control system is in the lead cut in mode and the pre-control pressure generated by the third magnet valve 201 and the fourth magnet valve 202 is not abnormal, the fifth magnet valve 207 is in an energized state.

As a preferred embodiment, in the brake cylinder control system 2, the second control unit 213 can be further electrically connected with a sixth magnet valve 209 which is a bail-off magnet valve. On one hand, the sixth magnet valve 209 is connected with the fourth magnet valve or is preferably connected with the fifth magnet valve 207 when there is the fifth magnet valve 207; and on the other hand, the sixth magnet valve 209 is connected with the second pressure selection device 204, and the sixth magnet valve 209 is further connected to the atmosphere. The sixth magnet valve 209 can be used for emptying the pre-control pressure of the brake cylinder at the rear end of the sixth magnet valve 209 when the locomotive braking control system is independently relieved.

As a preferred embodiment, in the brake cylinder equalizing pipe control system 1, a third pipeline 112 from the first flow amplification valve 106 to the second pressure selection device 204 is provided with a third pressure detection device 109, preferably to be a pressure sensor, for acquiring a brake cylinder equalizing pipe pressure value. The third pressure detection device 109 can be used for displaying and monitoring the brake cylinder equalizing pipe pressure in real time; and providing assistant judgment whether failure occurs on the first flow amplification valve 106 according to a difference of the first pressure and the actual brake cylinder equalizing pipe pressure.

As a preferred embodiment, in the brake cylinder control system 2, a fourth pipeline 215 from the second flow amplification valve 206 to the brake cylinder pipe 212 is provided with a fourth pressure detection device 211, preferably to be a pressure sensor, for acquiring a brake cylinder pressure value. The fourth pressure detection device 211 can be used for displaying and monitoring the brake cylinder pressure in real time; and providing assistant judgment whether failure occurs on the second flow amplification valve 206 according to a difference of the second pressure and the actual brake cylinder pressure.

As a preferred embodiment, a pressure at an outlet of the first flow amplification valve 106 is not greater than the first pressure from the first pressure selection device 104, to prevent the pressure instability caused by air connection of the second pressure selection device 204 when the pre-control pressure of the brake cylinder is close to the brake cylinder equalizing pipe pressure.

A second embodiment of the present application provides a locomotive braking control method which can be realized by the aforementioned locomotive braking control system. The locomotive braking control method includes the following steps.

(1) The first pressure detection device 105 acquires a pre-control pressure of the brake cylinder equalizing pipe control system 1 in real time and transmits the acquired pre-control pressure to the first control unit to obtain a pre-control pressure actual value of the brake cylinder equalizing pipe.

When the locomotive braking control system is in a lead cut in mode, the first control unit 110 receives instruction information output by a brake handle operated by a driver and calculates a pre-control pressure target value of the brake cylinder equalizing pipe according to the instruction information; or, the first control unit 110 receives a first target value from the integrated control unit 3, and when the locomotive braking control system is in the lead cut in mode, the integrated control unit 3 receives the instruction information output by the brake handle operated by the driver and calculates the first target value according to the instruction information, wherein the first target value and the pre-control pressure target value of the brake cylinder equalizing pipe are equal and are collectively referred to as a target value.

The first control unit 110 compares the target value with the actual value, and controls the first magnet valve 101 and/or the second magnet valve 102 according to a difference of the target value and the actual value so that the actual value is equal to the target value, thus obtain the pre-control pressure of the brake cylinder equalizing pipe; and transmits the pre-control pressure of the brake cylinder equalizing pipe to the first pressure selection device 104.

(2) The second pressure detection device 205 acquires a pre-control pressure of the brake cylinder control system 2 in real time and transmits the acquired pre-control pressure to the second control unit 213 to obtain a pre-control pressure actual value of the brake cylinder.

When the locomotive braking control system is in a lead cut in mode, the second control unit 213 receives the instruction information output by the brake handle operated by the driver and calculates a pre-control pressure target value of the brake cylinder according to the instruction information, wherein the pre-control pressure target value of the brake cylinder is equal to the pre-control pressure target value of the brake cylinder equalizing pipe; or, when the locomotive braking control system is in a lead cut in mode, the second control unit receives the first target value from the integrated control unit 3.

The second control unit compares the target value with the actual value, and controls the third magnet valve 201 and/or the fourth magnet valve 202 according to a difference of the target value and the actual value so that the actual value is equal to the target value, thus obtain the pre-control pressure of the brake cylinder; and transmits the pre-control pressure of the brake cylinder to the second pressure selection device 204 and the first pressure selection device 104.

(3) The first pressure selection device 104 compares the pre-control pressure of the brake cylinder equalizing pipe with the pre-control pressure of the brake cylinder, and outputs a higher pressure (referred to as a first pressure) among the pre-control pressure of the brake cylinder equalizing pipe and the pre-control pressure of the brake cylinder to the first flow amplification valve 106; and the first flow amplification valve 106 amplifies the first pressure with low-flow to a brake cylinder equalizing pipe pressure with high-flow, and then outputs the brake cylinder equalizing pipe pressure to the second pressure selection device 204.

(4) The second pressure selection device 204 compares the brake cylinder equalizing pipe pressure with the pre-control pressure of the brake cylinder, and outputs a higher pressure (referred to as a second pressure) among the brake cylinder equalizing pipe pressure and the pre-control pressure of the brake cylinder to the second flow amplification valve 206; and the second flow amplification valve 206 amplifies the second pressure with low-flow to a brake cylinder pressure with high-flow, and then outputs the brake cylinder pressure to the brake cylinder pipe 212 so as to realize brake.

The locomotive braking control method can be achieved by adopting the aforementioned locomotive braking control system, and therefore, the embodiments in the locomotive braking control system can also be effectively applied to the present method, include, but are not limited to the followings.

As a preferred embodiment, the pressure detection devices 105, 205 select from, but are not limited to, pressure sensors; the pressure selection devices 104, 204 can select from, but are not limited to, two-way valves or two-position three-way magnet valves; and the flow amplification valves 106, 206 can select from, but are not limited to, relay valves.

As a preferred embodiment, the second magnet valve 102 is further connected with a first pre-control reservoir 107 for increasing the pre-control volume of the brake cylinder equalizing pipe control system 1. The first pressure detection device 105 acquires a pre-control pressure of the first pre-control reservoir 107 in real time as the pre-control pressure actual value of the brake cylinder equalizing pipe, and sends to the first control unit 110. The fourth magnet valve 202 is further connected with a second pre-control reservoir 210 for increasing the pre-control volume of the brake cylinder control system 2. The second pressure detection device 205 can acquire the pre-control pressure of the second pre-control reservoir 210 in real time as the ore-control pressure actual value of the brake cylinder, and send to the second control unit 213.

As a preferred embodiment, the first control unit 110 is further electrically connected with a cut-off valve 108, and the cut-off valve 108 is located behind the first flow amplification valve 106. When the locomotive braking control system is in the lead cut in mode, the first control unit 110 controls the cut-off valve 108 to be de-energized, and the brake cylinder equalizing pipe pressure output pipeline is in a connected state.

As a preferred embodiment, the second control unit 213 is further electrically connected with a fifth magnet valve 207 which is a distribution valve switching magnet valve. When the fifth magnet valve 207 is energized, the pre-control pressure of the brake cylinder is from the pre-control pressure generated by the third magnet valve 201 and the fourth magnet valve 202; and when the fifth magnet valve 207 is de-energized, the pre-control pressure of the brake cylinder is from the mechanical distribution valve 208 which is externally connected. When the locomotive braking control system is in the lead cut in mode and the pre-control pressure generated by the third magnet valve 201 and the fourth magnet valve 202 is not abnormal, the fifth magnet valve 207 is in an energized state.

By using the locomotive braking control method provided by the present application, the redundancy switching between the brake cylinder equalizing pipe control system 1 and the brake cylinder control system 2 can be further realized:

when the pre-control pressure of the brake cylinder equalizing pipe is invalid, the first magnet valve 101 and the second magnet valve 102 are de-energized, the pre-control pressure of the brake cylinder equalizing pipe is gradually reduced to zero, and the first pressure selection device 104 selects the higher pre-control pressure of the brake cylinder as the first pressure to be output to the first flow amplification valve 106, and then the brake cylinder equalizing pipe pressure is output; or

when the pre-control pressure of the brake cylinder is invalid, the third magnet valve 201 and the fourth magnet valve 202 are de-energized, the pre-control pressure of the brake cylinder is gradually reduced to zero, and the second pressure selection device 204 selects the higher brake cylinder equalizing pipe pressure as the second pressure to be output to the second flow amplification valve 206, and then the brake cylinder pressure is output.

Or, more specifically,

(1) when failure occurs on the brake cylinder equalizing pipe control system 1:

the first control unit 110 acquires the pre-control pressure of the brake cylinder equalizing pipe in real time by the first pressure detection device 105, to obtain the pre-control pressure actual value of the brake cylinder equalizing pipe;

when the locomotive braking control system is in the lead cut in mode, the first control unit 110 compares the actual value with the target value, and controls the first magnet valve 101 and the second magnet valve 102 according to a comparison result;

if the actual value cannot be consistent with the target value within a preset time range, the first control unit 110 determines that failure occurs on the first magnet valve 101 or on the second magnet valve 102 or on the first pressure detection device 105, thus the three elements are de-energized, and the pre-control pressure of the brake cylinder equalizing pipe is discharged into the atmosphere by the second magnet valve 102; and

the pre-control pressure of the brake cylinder from the brake cylinder control system 2 is selected by the first pressure selection device 104 as a higher output, and is output to the first flow amplification valve 106, and then the brake cylinder equalizing pipe pressure is output.

Or,

(2) when failure occurs on the brake cylinder control system 2:

the second control unit 213 acquires the pre-control pressure of the brake cylinder in real time by the second pressure detection device 205, to obtain the pre-control pressure actual value of the brake cylinder;

when the locomotive braking control system is in the lead cut in mode, the second control unit 213 compares the actual value with the target value, and controls the third magnet valve 201 and the fourth magnet valve 202 according to a comparison result;

if the actual value cannot be consistent with the target value within a preset time range, the second control unit 213 determines that failure occurs on the third magnet valve 201 or on the fourth magnet valve 202 or on the second pressure detection device 205, thus the three elements are de-energized, and the pre-control pressure of the brake cylinder is discharged into the atmosphere by the fourth magnet valve 202; and

the brake cylinder equalizing pipe pressure from the brake cylinder equalizing pipe control system 1 is selected by the second pressure selection device 204 as a higher output and is output to the second flow amplification valve 206, and then the brake cylinder pressure is output.

When failure occurs on a pre-control part of the brake cylinder equalizing pipe control system 1 or that of the brake cylinder control system 2, the pre-control part of the brake cylinder equalizing pipe control system and that of the brake cylinder control system can be mutually redundant, so that the control precision and reliability of the system are effectively improved in the case that no air distribution valves or other configurations are added.

It should be noted that, in the present application, the first main reservoir 103 and the second main reservoir 203 can be the same main reservoir or different main reservoirs as long as functions in the present application can be achieved. The pressure selection device is preferably selected from a device with pressure comparison function, such as a two-way valve, so as not to be required to be additionally controlled by the control unit; of course, a two-position three-way valve can also be selected and controlled by the control unit, or other devices capable of achieving the above-mentioned purpose can also be selected. The flow amplification valve is preferably selected from device with flow amplification function, such as a relay valve, so as not to be required to be additionally controlled by the control unit, or other devices capable of achieving the above-mentioned purpose can also be selected. In the locomotive braking control system, the first control unit 110 and the second control unit 213 can also be further integrated into the integrated control unit 3 as long as the functions of the first control unit 110 and the second control unit 213 in the present application can be achieved.

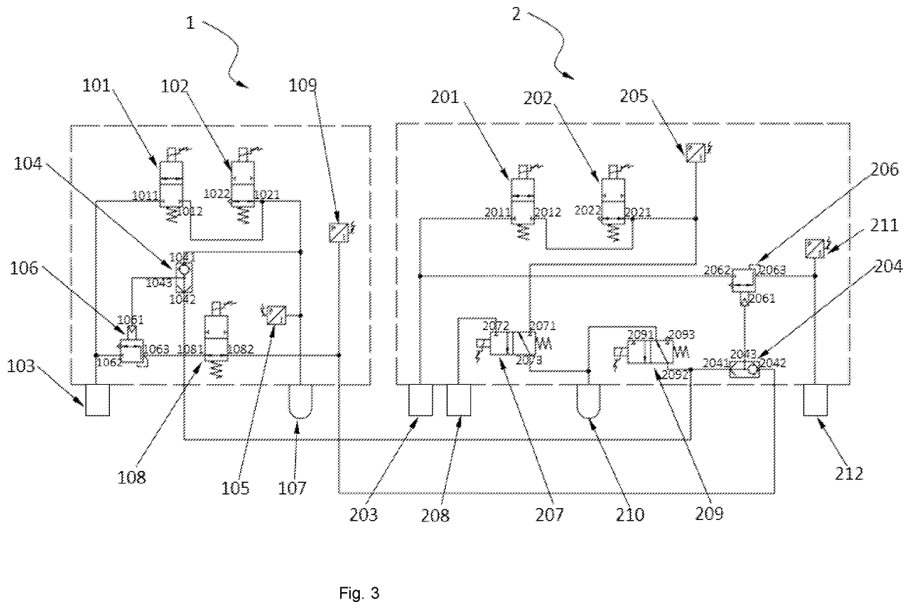

The present application will be described in detail below with reference to FIG. 3, FIG. 4 and embodiments. It should be understood that the present embodiment is only a preferred embodiment of the present application, and cannot be understood as a limitation on the protective scope of the present application.

(1) Brake cylinder equalizing pipe Control System:

The brake cylinder equalizing pipe control system 1 includes a first control unit 110, and the first control unit 110 is electrically connected with a first magnet valve 101, a second magnet valve 102, a cut-off valve 108 and a first pressure detection device 105; the first magnet valve 101 is a pre-control air-charging magnet valve, the second magnet valve 102 is a pre-control air-discharging magnet valve, and the first pressure detection device 105 is a pressure sensor; a first port 1011 of the first magnet valve 101 is connected to a first main reservoir 103, a second port 1012 of the first magnet valve 101 is connected to a first port 1021 of the second magnet valve 102, and a second port 1022 of the second magnet valve 102 is connected to the atmosphere; the first port 1021 of the second magnet valve 102 is further connected with a first port 1041 of a first two-way valve 104, and the first pressure detection device 105 is located between the first port 1021 and the first port 1041; and a second port 1042 of the first two-way valve 104 is connected with a brake cylinder control system 2, a third port 1043 of the first two-way valve 104 is connected with a first port 1061 of a first relay valve 106, a second port 1062 of the first relay valve 106 is connected with the first main reservoir 103, and a third port 1063 of the first relay valve 106 is connected with a first port 1081 of the cut-off valve 108, and a second port of the cut-off valve 108 is connected to the brake cylinder control system 2.
(2) Brake Cylinder Control System:

The brake cylinder control system 2 includes a second control unit 213, and the second control unit is electrically connected with a third magnet valve 201, a fourth magnet valve 202, a fifth magnet valve 207, a sixth magnet valve 209 and a second pressure detection device 205; the third magnet valve 201 is a pre-control air-charging magnet valve, the fourth magnet valve 202 is a pre-control air-discharging magnet valve, and the second pressure detection device 205 is a pressure sensor; a first port 2011 of the third magnet valve 201 is connected to a second main reservoir 203, a second port 2012 of the third magnet valve 201 is connected to a first port 2021 of the fourth magnet valve 202, and a second port 2022 of the fourth magnet valve 202 is connected to the atmosphere; the first port 2021 of the fourth magnet valve 202 is further connected with a first port 2071 of the fifth magnet valve 207, and the second pressure detection device 205 is located between the first port 2021 and the first port 2071; and a second port 2072 of the fifth magnet valve 207 is connected to a mechanical distribution valve 208, and a third port 2073 of the fifth magnet valve 207 is connected with a first port 2091 of the sixth magnet valve 209 and a second pre-control reservoir 210; the first port 2091 of the sixth magnet valve 209 is also connected with the second pre-control reservoir 210, a second port 2092 of the sixth magnet valve 209 is connected with a first port 2041 of a second two-way valve 204 and the second port 1042 of the first two-way valve 104, and a third port 2093 of the sixth magnet valve 209 is connected to the atmosphere; and a second port 2042 of the second two-way valve 204 is connected with a second port 1802 of the cut-off valve 108, a third port 2043 of the second two-way valve 204 is connected with a first port 2061 of a second relay valve 206, a second port 2062 of the second relay valve 206 is connected with a second main reservoir 203, and a third port 2063 of the second relay valve 206 is connected with a brake cylinder pipe 212, so that brake may be realized.
(3) Working Description:

When the locomotive braking control system is in the lead cut in mode, the first control unit 110 receives instruction information output by an automatic brake handle and an independent handle operated by the driver, calculates the pre-control pressure target value of the brake cylinder equalizing pipe according to the instruction information, compares the target value with the pre-control pressure actual value of the brake cylinder equalizing pipe which is acquired by the first pressure detection device 105, and controls the first magnet valve 101 and/or the second magnet valve 102 according to the difference of the target value and the actual value so that the actual value is equal to the target value, thus obtain the pre-control pressure of the brake cylinder equalizing pipe. Specifically, when the actual value is greater than the target value, the second magnet valve 102 is controlled to discharge air to the atmosphere through the second port 1022 thereof to reduce the actual value, so that the actual value is equal to the target value; and when the actual value is smaller than the target value, the first magnet valve 101 is controlled to charge air to the first pre-control reservoir 107 through the first main reservoir 103 to increase the actual value, so that the actual value is equal to the target value. Meanwhile, the first control unit controls the cut-off valve 108 to be de-energized, so that the brake cylinder equalizing pipe pressure output pipeline is in the connected state.

Similarly, when the locomotive braking control system is in the lead cut in mode, the second control unit 213 receives the instruction information output by the automatic brake handle and the independent brake handle operated by the driver, calculates the pre-control pressure target value of the brake cylinder according to the instruction information, compares the target value with a pre-control pressure actual value of the brake cylinder which is acquired by the second pressure detection device 205, and controls the third magnet valve 201 and/or the fourth magnet valve 202 according to the difference of the target value and the actual value so that the actual value is equal to the target value, thus obtain the pre-control pressure of the brake cylinder. Specifically, when the actual value is greater than the target value, the fourth magnet valve 202 is controlled to discharge air to the atmosphere through the second port 2022 thereof to reduce the actual value, so that the actual value is equal to the target value; and when the actual value is smaller than the target value, the third magnet valve 201 is controlled to charge air to a second pre-control reservoir 210 through the second main reservoir 203 to increase the actual value, so that the actual value is equal to the target value. Meanwhile, the second control unit controls the fifth magnet valve 207 to be energized, so that the first port 2071 is connected with the third port 2073; the second control unit controls the sixth magnet valve 209 to be de-energized, so that the first port 2091 is connected with the second port 2092, thus the brake cylinder pre-control pressure output pipeline is in the connected state; and therefore, the pre-control pressure of the brake cylinder can arrive at the second port 1042 of the first two-way valve 104 and the first port 2041 of the second two-way valve 204 through the fifth magnet valve 207 and the sixth magnet valve 209.

Or, when the locomotive braking control system is in the lead cut in mode, the integrated control unit 3 is used to receive the instruction information output by the automatic brake handle and the independent brake handle operated by the driver, calculate the pre-control pressure target value of the brake cylinder according to the instruction information, and transmit the target value to the first control unit 110 and the second control unit 213 respectively so as to realize the comparison and control of the target value and the actual value.

The first two-way valve 104 is used to compare the pre-control pressure of the brake cylinder equalizing pipe from the first port 1041 with the pre-control pressure of the brake cylinder from the second port 1042, and output the higher pressure (i.e., the first pressure) among the pre-control pressure of the brake cylinder equalizing pipe and the pre-control pressure of the brake cylinder to the first port 1061 of the first relay valve 106.

The first relay valve 106 is used to amplify the first pressure with low-flow to the brake cylinder equalizing pipe pressure with high-flow, flowing out of the third port 1063 of the first relay valve, and being transmitted to the second port 2042 of the second two-way valve 204 through the cut-off valve 108.

The second two-way valve 204 is used to compare the pre-control pressure of the brake cylinder from the first port 2041 with the brake cylinder equalizing pipe pressure from the second port 2042, and output the higher pressure (i.e., the second pressure) among the pre-control pressure of the brake cylinder and the brake cylinder equalizing pipe pressure to the first port 2061 of the second relay valve 206.

The second relay valve 206 is used to amplify the second pressure with low-flow to the brake cylinder pressure with high-flow, and transmit the brake cylinder pressure to the brake cylinder pipe 212 through the third port 2063 so as to realize brake.

The fifth magnet valve 207 is a distribution valve switching magnet valve and is used for switching and selecting a source of the pre-control pressure of the brake cylinder. Specifically, when the fifth magnet valve 207 is energized, the first port 2071 is connected with the third port 2073, and the pre-control pressure of the brake cylinder is the pre-control pressure from rear ends of the third magnet valve 201 and the fourth magnet valve 202; and when the fifth magnet valve 207 is de-energized, the second port 2072 is connected with the third port 2073, the pre-control pressure of the brake cylinder is from the mechanical distribution valve 208 which is externally connected. When the locomotive braking control system is in the lead cut in mode and the pre-control pressure of the brake cylinder generated by the third magnet valve 201 and/or the fourth magnet valve 202 is not abnormal, the fifth magnet valve 207 is in the energized state.

The sixth magnet valve 209 is a bail-off magnet valve and can be used for emptying the pre-control pressure of the brake cylinder at the rear end of the sixth magnet valve 209 when the locomotive braking control system is independently relieved. When the locomotive braking control system is in the lead cut in mode and in a normal working state, the sixth magnet valve 209 is de-energized, and the first port 2091 is connected with the second port 2092, so that the brake cylinder pre-control pressure output pipeline is in the connected state.

In addition, when an actual pressure difference of the first port 2041 and the second port 2042 of the second two-wavy valve 204 is not greater than the tolerable pressure difference of the second two-wavy valve 204 itself, air connection between the first port 2041 and the second port 2042 can occur. Therefore, when the pre-control pressure of the brake cylinder at the first port 2041 of the second two-way valve is close to the brake cylinder equalizing pipe pressure at the second port 2042, air connection between the two ports occurs; if the pressure P1 at the third port 1063 of the first relay valve is higher than the pressure P2 at the first port 1061, the pressure at the first port 2041 of the second two-way valve=the pressure at the second port 1042 of the first two-way valve=the pressure of the third port 1043 of the first two-way valve=the pressure at the first port 1061 of the first relay valve=P1>P2, and therefore, the pressure at the first port 1061 of the first relay valve becomes higher and higher.

For example, if under a general condition the pressure at the third port 1063 of the first relay valve is always 5 kPa (smaller than or equal to the tolerable pressure difference of the two-way valve) greater than the pressure at the first port 1061, taking the pressure at the first port 1061 of the first relay valve is 90 kpa as an example, the pressure at the third port 1063 of the first relay valve is 95 kPa, and the pressure at the second port 2042 of the second two-way valve is 95 kPa; and since the pre-control pressure of the brake cylinder at the first port 2041 of the second two-way valve is close to the brake cylinder equalizing pipe pressure at the second port 2042, air connection between the first port 2041 and the second port 2042 is caused, then the pressure at the first port 2041 of the second two-way valve is 95 kPa, the pressure at the second port 1042 of the first two-way valve is 95 kPa, and the pressure at the third port 1043 of the first two-way valve is 95 kPa, that is, the pressure at the first port 1061 of the first relay valve is 95 kPa; compared with the original 90 kPa, it is increased by 5 kPa. By such circulation, the brake cylinder equalizing pipe pressure will finally increase to the pressure of the main reservoir, thereby affecting the operation of the locomotive.

Therefore, in present technical solution, the pressure at the output port (i.e., the third port 1063) of the first relay valve is preferably not greater than the pressure at the first port 1061 all the time, so that the normal operation of the locomotive is prevented from being affected.
(4) Redundancy Description:

Due to the above-mentioned arrangement, redundancy switching between the brake cylinder equalizing pipe control system and the brake cylinder control system can be performed. Specifically, the first control unit and the second control unit are capable of simultaneously outputting corresponding pressures in response to the operation of the driver operating the automatic brake handle and the independent brake handle, and the target values of both are consistent.

The first two-way valve 104 outputs a higher pressure among the pre-control pressure of the brake cylinder equalizing pipe and the pre-control pressure of the brake cylinder to the first port 1061 of the first relay valve 106, and outputs the brake cylinder equalizing pipe pressure after the pressure of the first port 1061 is subjected to flow amplification through the output port (i.e., the third port 1063) of the first relay valve.

The second two-way valve 204 outputs a higher pressure among the pre-control pressure of the brake cylinder and the brake cylinder equalizing pipe pressure to the first port 2061 of the second relay valve 206, and outputs the brake cylinder pressure after the pressure of the first port 2061 is subjected to flow amplification through an output port (i.e., the third port 2063) of the second relay valve.

The first port and the second port are open when the pre-control air-discharging magnet valve 102, 202 is de-energized, and the first port and the second port are closed when the pre-control air-charging magnet valve 101, 201 is de-energized; therefore, the pre-control pressure of the brake cylinder equalizing pipe and the pre-control pressure of the brake cylinder can be gradually reduced to zero when both being de-energized;

when the pre-control pressure of the brake cylinder equalizing pipe is invalid, the first magnet valve 101 and the second magnet valve 102 are de-energized, the pre-control pressure of the brake cylinder equalizing pipe is gradually reduced to zero, and the first two-way valve 104 outputs the pre-control pressure of the brake cylinder with higher output to the first relay valve 106, and then outputs the brake cylinder equalizing pipe pressure; and when the pre-control pressure of the brake cylinder is invalid, the third magnet valve 201 and the fourth magnet valve 202 are de-energized, the pre-control pressure of the brake cylinder is gradually reduced to zero, and the second two-way valve 204 outputs the brake cylinder equalizing pipe pressure with higher output to the second relay valve 206, and then outputs the brake cylinder pressure.

In summary, the mutually redundancy of the brake cylinder control system and the brake cylinder equalizing pipe control system can be realized in the present application.

1. A locomotive braking control system, comprising a brake cylinder equalizing pipe control system and a brake cylinder control system, wherein,
the brake cylinder equalizing pipe control system includes:
a first main reservoir;
a first magnet valve and a first flow amplification valve both connected with the first main reservoir;
a second magnet valve connected with the first magnet valve;
a first pressure selection device connected with the second magnet valve, and a first pressure detection device located between the second magnet valve and the first pressure selection device;
wherein, the first pressure selection device is connected with the first flow amplification valve; and
the brake cylinder equalizing pipe control system further includes a first control unit electrically connected with the first magnet valve, the second magnet valve and the first pressure detection device;
the brake cylinder control system includes:
a second main reservoir;
a third magnet valve and a second flow amplification valve both connected with the second main reservoir;
a fourth magnet valve connected with the third magnet valve;
a second pressure selection device connected with the fourth magnet valve, and a second pressure detection device located between the fourth magnet valve and the second pressure selection device;
wherein, the second pressure selection device is connected with the second flow amplification valve;
the second flow amplification valve is connected with a brake cylinder pipe so as to realize brake; and
the brake cylinder control system further includes a second control unit electrically connected with the third magnet valve, the fourth magnet valve and the second pressure detection device;
between the brake cylinder equalizing pipe control system and the brake cylinder control system:
the first pressure selection device is connected to a pipeline located between the fourth magnet valve and the second pressure selection device; and
the first flow amplification valve is connected to the second pressure selection device;
further,
the first pressure detection device is configured to acquire a pre-control pressure of the brake cylinder equalizing pipe control system in real time and transmit the acquired pre-control pressure to the first control unit, thus obtain a pre-control pressure actual value of the brake cylinder equalizing pipe;
the first control unit is configured to, when the locomotive braking control system is in a lead cut in mode, receive instruction information output by a brake handle operated by a driver and calculate a pre-control pressure target value of the brake cylinder equalizing pipe according to the instruction information;
the first control unit is further configured to compare the target value with the actual value acquired by the first pressure detection device, and control the first magnet valve and/or the second magnet valve according to a difference of the target value and the actual value so that the actual value is equal to the target value, thus obtain the pre-control pressure of the brake cylinder equalizing pipe; and transmit the pre-control pressure of the brake cylinder equalizing pipe to the first pressure selection device;
the first magnet valve is a pre-control air-charging magnet valve, and is configured to open or close an air-charging passage from the first main reservoir to a pre-control volume of the brake cylinder equalizing pipe control system according to the difference of the pre-control pressure target value of the brake cylinder equalizing pipe and the pre-control pressure actual value of the brake cylinder equalizing pipe;
the second magnet valve is a pre-control air-discharging magnet valve, and is configured to open or close an air-discharging passage from the pre-control volume of the brake cylinder equalizing pipe control system to the atmosphere according to the difference of the pre-control pressure target value of the brake cylinder equalizing pipe and the pre-control pressure actual value of the brake cylinder equalizing pipe;
the first pressure selection device is configured to compare the pre-control pressure of the brake cylinder equalizing pipe with a pre-control pressure of the brake cylinder, and output a higher pressure, referred to as a first pressure, among the pre-control pressure of the brake cylinder equalizing pipe and the pre-control pressure of the brake cylinder to the first flow amplification valve; and the pre-control pressure of the brake cylinder is from the brake cylinder control system;
the first flow amplification valve is configured to amplify the first pressure with low-flow to a brake cylinder equalizing pipe pressure with high-flow;
the second pressure detection device is configured to acquire a pre-control pressure of the brake cylinder control system in real time and transmit the acquired pre-control pressure to the second control unit, thus obtain a pre-control pressure actual value of the brake cylinder;
the second control unit is configured to, when the locomotive braking control system is in the lead cut in mode, receive the instruction information output by the brake handle operated by the driver and calculate a pre-control pressure target value of the brake cylinder according to the instruction information, wherein the pre-control pressure target value of the brake cylinder and the pre-control pressure target value of the brake cylinder equalizing pipe are equal;
the second control unit is further configured to compare the target value with the actual value acquired by the second pressure detection device, and control the third magnet valve and/or the fourth magnet valve according to a difference of the target value and the actual value so that the actual value is equal to the target value, thus obtain the pre-control pressure of the brake cylinder; and transmit the pre-control pressure of the brake cylinder to the second pressure selection device and the first pressure selection device;
the third magnet valve is a pre-control air-charging magnet valve, and is configured to open or close an air-charging passage from the second main reservoir to a pre-control volume of the brake cylinder control system according to the difference of the pre-control pressure target value of the brake cylinder and the pre-control pressure actual value of the of the brake cylinder;
the fourth magnet valve is a pre-control air-discharging magnet valve, and is configured to open or close an air-discharging passage from the pre-control volume of the brake cylinder control system to the atmosphere according to the difference of the pre-control pressure target value of the brake cylinder and the pre-control pressure actual value of the brake cylinder;
the second pressure selection device is configured to compare the brake cylinder equalizing pipe pressure with the pre-control pressure of the brake cylinder, and output a higher pressure, referred to as a second pressure, among the brake cylinder equalizing pipe pressure and the pre-control pressure of the brake cylinder to the second flow amplification valve; and the brake cylinder equalizing pipe pressure is from the brake cylinder equalizing pipe control system;
the second flow amplification valve is configured to amplify the second pressure with low-flow to a brake cylinder pressure with high-flow, and transmit the brake cylinder pressure to the brake cylinder pipe, to realize brake.

2. The control system according to claim 1, wherein, the first control unit and the second control unit receive the first target value from the integrated control unit; and the integrated control unit is configured to, when the locomotive braking control system is in the lead cut in mode, receive the instruction information output by the brake handle operated by the driver and calculate a first target value according to the instruction information, wherein the first target value, the pre-control pressure target value of the brake cylinder equalizing pipe and the pre-control pressure target value of the brake cylinder are equal, and are collectively referred to as a target value.

3. The control system according to claim 1, wherein, the pressure detection devices select pressure sensors; the pressure selection devices select two-way valves, or two-position three-way magnet valves; the flow amplification valves select relay valves; and the first main reservoir and the second main reservoir are the same main reservoir or different main reservoirs.

4. The control system according to claim 1, wherein, the second magnet valve is further connected with a first pre-control reservoir to increase the pre-control volume of the brake cylinder equalizing pipe control system; and the fourth magnet valve is further connected with a second pre-control reservoir to increase the pre-control volume of the brake cylinder control system.

5. The control system according to claim 1, wherein, the first control unit is further electrically connected with a cut-off valve; and the cut-off valve is located in the brake cylinder equalizing pipe control system and located behind the first flow amplification valve, for opening or closing a brake cylinder equalizing pipe pressure output pipeline of the brake cylinder equalizing pipe control system.

6. The control system according to claim 1, wherein, the second control unit is further electrically connected with a fifth magnet valve which is a distribution valve switching magnet valve, for switching and selecting a source of the pre-control pressure of the brake cylinder.

7. The control system according to claim 6, wherein, the second control unit is further electrically connected with a sixth magnet valve which is a bail-off magnet valve; on one hand, the sixth magnet valve is connected with the fifth magnet valve, on the other hand, the sixth magnet valve is connected with the second pressure selection device, and the sixth magnet valve is further connected to the atmosphere.

8. The control system according to claim 1, wherein, a third pipeline from the first flow amplification valve to the second pressure selection device is provided with a third pressure detection device, for acquiring a brake cylinder equalizing pipe pressure value; and a fourth pipeline from the second flow amplification valve to the brake cylinder pipe is provided with a fourth pressure detection device, for acquiring a brake cylinder pressure value.

9. The control system according to claim 1, wherein, a pressure at an outlet of the first flow amplification valve is not greater than the first pressure from the first pressure selection device.

10. The control system according to claim 3, wherein, the second magnet valve is further connected with a first pre-control reservoir to increase the pre-control volume of the brake cylinder equalizing pipe control system; and the fourth magnet valve is further connected with a second pre-control reservoir to increase the pre-control volume of the brake cylinder control system.

11. The control system according to claim 10, wherein, the first control unit is further electrically connected with a cut-off valve; and the cut-off valve is located in the brake cylinder equalizing pipe control system and located behind the first flow amplification valve, for opening or closing a brake cylinder equalizing pipe pressure output pipeline of the brake cylinder equalizing pipe control system.

12. The control system according to claim 11, wherein, the second control unit is further electrically connected with a fifth magnet valve which is a distribution valve switching magnet valve, for switching and selecting a source of the pre-control pressure of the brake cylinder.

13. The control system according to claim 12, wherein, the second control unit is further electrically connected with a sixth magnet valve which is a bail-off magnet valve; on one hand, the sixth magnet valve is connected with the fifth magnet valve, on the other hand, the sixth magnet valve is connected with the second pressure selection device, and the sixth magnet valve is further connected to the atmosphere.

14. The control system according to claim 4, wherein, the first control unit is further electrically connected with a cut-off valve; and the cut-off valve is located in the brake cylinder equalizing pipe control system and located behind the first flow amplification valve, for opening or closing a brake cylinder equalizing pipe pressure output pipeline of the brake cylinder equalizing pipe control system.

15. The control system according to claim 14, wherein, the second control unit is further electrically connected with a fifth magnet valve which is a distribution valve switching magnet valve, for switching and selecting a source of the pre-control pressure of the brake cylinder.

16. The control system according to claim 15, wherein, the second control unit is further electrically connected with a sixth magnet valve which is a bail-off magnet valve; on one hand, the sixth magnet valve is connected with the fifth magnet valve, on the other hand, the sixth magnet valve is connected with the second pressure selection device, and the sixth magnet valve is further connected to the atmosphere.

17. The control system according to claim 4, wherein, a pressure at an outlet of the first flow amplification valve is not greater than the first pressure from the first pressure selection device.

18. A locomotive braking control method, adopting the control system of claim 1, comprising the following steps:
acquiring, by the first pressure detection device, a pre-control pressure of the brake cylinder equalizing pipe control system in real time, and transmitting the acquired pre-control pressure to the first control unit, thus obtaining a pre-control pressure actual value of the brake cylinder equalizing pipe;
when the locomotive braking control system is in a lead cut in mode, receiving, by the first control unit, instruction information output by a brake handle operated by a driver, and calculating a pre-control pressure target value of the brake cylinder equalizing pipe according to the instruction information;
comparing, by the first control unit, the target value with the actual value, and controlling the first magnet valve and/or the second magnet valve according to a difference of the target value and the actual value so that the actual value is equal to the target value, thus obtaining the pre-control pressure of the brake cylinder equalizing pipe; and transmitting the pre-control pressure of the brake cylinder equalizing pipe to the first pressure selection device;
acquiring, by the second pressure detection device, a pre-control pressure of the brake cylinder control system in real time, and transmitting the acquired pre-control pressure to the second control unit, thus obtaining a pre-control pressure actual value of the brake cylinder;
when the locomotive braking control system is in the lead cut in mode, receiving, by the second control unit, instruction information output by the brake handle operated by the driver, and calculating a pre-control pressure target value of the brake cylinder according to the instruction information, wherein the pre-control pressure target value of the brake cylinder and the pre-control pressure target value of the brake cylinder equalizing pipe are equal;
comparing, by the second control unit, the target value with the actual value, and controlling the third magnet valve and/or the fourth magnet valve according to a difference of the target value and the actual value so that the actual value is equal to the target value, thus obtaining the pre-control pressure of the brake cylinder; and transmitting the pre-control pressure of the brake cylinder to the second pressure selection device and the first pressure selection device;
comparing, by the first pressure selection device, the pre-control pressure of the brake cylinder equalizing pipe with the pre-control pressure of the brake cylinder, and outputting a higher pressure, referred to as a first pressure, among the pre-control pressure of the brake cylinder equalizing pipe and the pre-control pressure of the brake cylinder to the first flow amplification valve;
amplifying, by the first flow amplification valve, the first pressure with low-flow to a brake cylinder equalizing pipe pressure with high-flow, and outputting the brake cylinder equalizing pipe pressure to the second pressure selection device;
comparing, by the second pressure selection device, the brake cylinder equalizing pipe pressure with the pre-control pressure of the brake cylinder, and outputting a higher pressure, referred to as a second pressure, among the brake cylinder equalizing pipe pressure and the pre-control pressure of the brake cylinder to the second flow amplification valve; and
amplifying, by the second flow amplification valve, the second pressure with low-flow to a brake cylinder pressure with high-flow, and transmitting the brake cylinder pressure to the brake cylinder pipe so as to realize brake.

19. The control method according to claim 18, wherein,
when the pre-control pressure of the brake cylinder equalizing pipe is invalid, the first magnet valve and the second magnet valve are de-energized, the pre-control pressure of the brake cylinder equalizing pipe is gradually reduced to zero, and the first pressure selection device selects the higher pre-control pressure of the brake cylinder as the first pressure to be output to the first flow amplification valve, and then the brake cylinder equalizing pipe pressure is output; or
when the pre-control pressure of the brake cylinder is invalid, the third magnet valve and the fourth magnet valve are de-energized, the pre-control pressure of the brake cylinder is gradually reduced to zero, and the second pressure selection device selects the higher brake cylinder equalizing pipe pressure as the second pressure to be output to the second flow amplification valve, and then the brake cylinder pressure is output.

20. The control method according to claim 18, wherein,
the first control unit acquires the pre-control pressure of the brake cylinder equalizing pipe in real time by the first pressure detection device, to obtain the pre-control pressure actual value of the brake cylinder equalizing pipe; when the locomotive braking control system is in the lead cut in mode, the first control unit compares the actual value with the target value, and controls the first magnet valve and the second magnet valve according to a comparison result; if the actual value cannot be consistent with the target value within a preset time range, the first control unit determines that failure occurs on the first magnet valve or on the second magnet valve or on the first pressure detection device, thus the three elements are de-energized, and the pre-control pressure of the brake cylinder equalizing pipe is discharged into the atmosphere by the second magnet valve; and the pre-control pressure of the brake cylinder from the brake cylinder control system is selected by the first pressure selection device as a higher output, and is output to the first flow amplification valve, and then the brake cylinder equalizing pipe pressure is output; or,
the second control unit acquires the pre-control pressure of the brake cylinder in real time by the second pressure detection device, to obtain the pre-control pressure actual value of the brake cylinder; when the locomotive braking control system is in the lead cut in mode, the second control unit compares the actual value with the target value, and controls the third magnet valve and the fourth magnet valve according to a comparison result; if the actual value cannot be consistent with the target value within a preset time range, the second control unit determines that failure occurs on the third magnet valve or on the fourth magnet valve or on the second pressure detection device, thus the three elements are de-energized, and the pre-control pressure of the brake cylinder is discharged into the atmosphere by the fourth magnet valve; and the brake cylinder equalizing pipe pressure from the brake cylinder equalizing pipe control system is selected by the second pressure selection device as a higher output and is output to the second flow amplification valve, and then the brake cylinder pressure is output.
